(19) United States
(12) Patent Application Publication
(10) Pub. No.: US 2025/0310837 A1
(43) Pub. Date: Oct. 2, 2025

(54) SUPPORTING USER EQUIPMENT POLICIES PROVISIONING VIA A SECOND SYSTEM AT INTER-SYSTEM HANDOVER FROM A FIRST SYSTEM

(71) Applicant: TELEFONAKTIEBOLAGET LM ERICSSON (PUBL), Stockholm (SE)

(72) Inventors: ANTONIO INIESTA GONZALEZ, Madrid (ES); JUYING GAN, Shanghai (CN); MARIA BELEN PANCORBO MARCOS, Madrid (ES)

(21) Appl. No.: 18/863,004

(22) PCT Filed: May 8, 2023
(86) PCT No.: PCT/IB2023/054761

§ 371 Date: Nov. 5, 2024

(30) Foreign Application Priority Data
May 6, 2022 (WO) PCT/CN2022/091136

(51) Int. Cl. H04W 36/00

(52) U.S. Cl. CPC H04W 36/00222; H04W 36/0064

(57) ABSTRACT

A method and system are provided describing a policy control function for a UE determining whether UE policies should be updated at the UE when the UE moves from a first system to a second system using an established UE policy association established by a session management policy control function, and based on an indication that the UE has handover to the second system and another indication that the UE supports receiving the UE policies update over the second system. The UE may provide the indication of the capability to receive UE policies update over the second system at registration in the first system. Furthermore, if the UE moves back to the first system, the session management policy control function cancels the UE policy association established with the policy control function for the UE policies.

### TECHNICAL FIELD

The present invention generally relates to provisioning of User Equipment (UE) policies in a mobile or communications network and more specifically, the invention relates to the provisioning of UE policies when the UE moves from a a first system to a second system.

### BACKGROUND

The UE policy control, as described in third generation partnership project (3GPP) technical specification (TS) 23.503 in a 5G system (5GS), enables the Policy Control Function (PCF) using Npcf and Namf service operations to provide to the UE, Access network discovery & selection policies (ANDSP), Packet Data Unit session (PDU) Session related policy information such as UE Route Selection Policies (URSP) and/or Vehicle to anything (V2X) Policies and/or proximity (ProSe) Policies (ProSeP).

The procedure for delivery of UE policies in 5G system (5GS) is described in TS 23.503 V.17.4.0 and 23.502 V. 17.4.0 (both incorporated herein by reference) and key sections are reproduced for clarity under the header “Distribution of the policies to the UE”.

### Distribution of the Policies to UE

The PCF may be triggered to provide the UE policy information (UE policies) during UE Policy Association Establishment and UE Policy Association Modification procedures as defined in clause 4.16.11 and clause 4.16.12 of TS 23.502.
NOTE 1: The PCF can install a PCC Rule and activate start and stop of application detection in the SMF. When the same PCF is selected for SM policy association control and UE policy association control, the reporting of start and stop of an application can trigger the installation or update of a URSP rule in the UE to send the application traffic to the PDU Session as defined in the URSP rule.
NOTE 2: The PCF can subscribe to the UDR on service specific information change, which will be taken into consideration by the PCF to determine the updated V2XP and ProSeP as defined in clause 4.15.6.7 of TS 23.502.

Operator defined policies in the PCF may depend on input data such as UE location, time of day, information provided by other NFs, etc.

The PCF includes the UE policy information delivered to the UE into a Policy Section identified by a Policy Section Identifier (PSI). The PCF may divide the UE policy information into different Policy Sections, each one identified by a PSI. Each Policy Section provides a list of self-contained UE policy information to the UE, via AMF. The PCF ensures that a Policy Section is under a predefined size limit, known by the PCF.
NOTE 3: The size limit to allow the policy information to be delivered using NAS transport is specified in TS 29.507. The size limit is configured in the PCF.

A list of self-contained UE policy information implies that:
when the PCF delivers URSP rules to the UE, the PCF provides the list of URSP rules in the order of precedence and without splitting a URSP rule across Policy Sections;
when the PCF delivers V2XP to the UE, the PCF provides the list of V2XP in the order of precedence and without splitting a V2XP across Policy Sections;
when the PCF delivers ProSeP to the UE, the PCF provides the list of ProSeP in the order of precedence and without splitting a ProSeP across Policy Sections;
when the PCF delivers WLANSP rules, the list of WLANSP rules are provided in the order of priority and without splitting a WLANSP rule across Policy Sections;
when the PCF delivers the non-3GPP access network selection information, the whole list of non-3GPP access network selection information is provided in one Policy Section.

It is up to PCF decision how to divide the UE policy information into Policy Sections as long as the requirements for the predefined size limit and the self-contained content (described above) are fulfilled.
NOTE 4: The Policy Section list can be different per user. One PSI and its corresponding content can be the same for one or more users.
NOTE 5: The PCF may, for example, assign the URSP as one whole Policy Section, or it may subdivide the information in the URSP into multiple Policy Sections by assigning one or several URSP rules to each Policy Section.

The PLMN ID is provided to the UE together with UE policy information and it is used to indicate which PLMN a Policy Section list belongs to.

The AMF forwards the UE policy information transparently to the UE. If the (H-) PCF decides to split the UE policies to be sent to the UE, the PCF provides multiple Policy Sections separately to the AMF and then AMF uses UE configuration Update procedure for transparent UE policies delivery procedure to deliver the policies to the UE.
NOTE 6: The AMF does not need to understand the content of the UE policy, rather send them to the UE for storage.

The UE shall update the stored UE policy information with the one provided by the PCF as follows:
If the UE has no Policy Sections with the same PSI, the UE stores the Policy Section;
If the UE has an existing Policy Section with the same PSI, the UE replaces the stored Policy Section with the received information;
The UE removes the stored Policy Section if the received information contains only the PSI.

The UE keeps the received UE policies even when registering in another PLMN.

At Initial Registration or the Registration to 5GS when the UE moves from EPS to 5GS:
The UE provides the list of stored PSIs which identify the Policy Sections associated to the home PLMN and the visited PLMN (if the UE is roaming) that are currently stored in the UE. If USIM is changed, the UE does not provide any PSI. If no policies are stored in the UE for the home PLMN, the UE does not provide any PSI associated to the home PLMN. If the UE is roaming and has policies for the home PLMN but no associated policies for the visited PLMN the UE includes only the list of PSIs associated to the home PLMN.
UE may indicate its ANDSP support to the PCF. If it is received, the PCF shall take it into account for the determination on whether to provide the ANDSP to the UE. The PCF does not provide ANDSP rules to the UE if the UE does not indicate support for ANDSP.
UE may indicate the V2X Policy Provisioning Request in the UE Policy Container. If this indication is received, the PCF includes V2XP in the UE policy information.
UE may indicate the 5G ProSe Policy and Parameter Provisioning Request in the UE Policy Container. If this indication is received, the PCF includes ProSeP in the UE policy information. PCF determines contents of ProSeP based on the information contained in the 5G ProSe Policy and Parameter Provisioning Request.
The UE may also provide the OSId (i.e., the operating system identifier).

The UE may trigger an Initial registration with the list of stored PSIs to request a synchronization for example if the UE powers up without USIM being changed.

During Initial Registration, the (H-) PCF retrieves the list of PSIs and its content stored in the home User data repositary (H-) UDR for this SUPI while the V-PCF (in the roaming scenario) retrieves the list of PSIs and its content stored in the visited UDR (V-UDR) for the PLMN ID of this UE (alternatively, the V-PCF can have this information configured locally).
NOTE 7: The PSI list and content stored/configured for a PLMN ID can be structured according to e.g. location areas (e.g. TAs, PRAs). The V-PCF can then provide PSIs and its content only if they correspond to the current UE location.

In the roaming scenario, the V-PCF shall also forward any UE provided PSIs that are associated to the home PLMN to the H-PCF.

When the PCF (i.e. the (H-) PCF as well as the V-PCF) receives a list of PSIs associated to the PLMN of the PCF from the UE, the PCF compares the list of PSIs provided by the UE and the list of PSIs retrieved from the UDR. In addition, the PCF checks whether the list of PSIs provided by the UE or its content needs to be updated according to operator policies, e.g. change of Location and/or time. If the two lists of PSIs are different or an update is necessary according to operator policies (which includes the case that the UE did not provide a list of PSIs associated to the PLMN of the PCF), the PCF provides the changes in the list of PSIs or the corresponding content to the AMF which forwards them to the UE.

The (H-) PCF maintains the latest list of PSIs delivered to each UE as part of the information related to the Policy Association until the UE policy association termination request is received from the AMF. Then the (H-) PCF stores the latest list of PSIs and its contents in the (H-) UDR using the Nudr_DM_Update including DataSet “Policy Data” and Data Subset “Policy Set Entry”.

The (H-) PCF may use the PEI provided by the AMF and/or the OSId provided by the UE, to determine the operating system of the UE.

If the PEI, the OSId or the indication of UE support for ANDSP is available to the PCF, the PCF stores them in the UDR using Nudr_DM_Create including DataSet “Policy Data” and Data Subset “UE context policy control data” when such information is received from the UE in the UE Policy Container.

If the (H-) PCF is not able to determine the operating system of the UE, and if the (H-) PCF requires to deliver URSP rules that contain Application descriptors as Traffic Descriptors, then the Traffic Descriptors of such URSP rules include multiple instances of Application descriptors each associated to supported UE operating systems by the network operator implementation. If the (H-) PCF determines the operating system of the UE and if the (H-) PCF requires to deliver URSP rules that contain Application descriptors as Traffic Descriptors, then the Traffic Descriptors of such URSP rules include the Application descriptors associated with the operating system determined by the PCF.
NOTE 8: If the PCF does not take into account the received PEI and/or OSId then the PCF can send URSP rules containing application traffic descriptors associated to multiple operating systems.

In addition, 3GPP TS 23.502 v17.3.0 describes the AMF in 5GS using the UE Configuration Update procedure to provide updated policies to the UE. The details of that procedure are reproduced below and illustrated in FIG. 4 (prior art):

UE Configuration Update procedure for transparent UE Policy delivery

This procedure is initiated when the PCF wants to update UE policy information (i.e., UE policy) in the UE configuration. In the non-roaming case, the V-PCF is not involved and the role of the H-PCF is performed by the PCF. For the roaming scenarios, the V-PCF interacts with the AMF and the H-PCF interacts with the V-PCF. (see FIG. 4 prior art)

0. PCF decides to update UE policy based on triggering conditions such as an initial registration, registration with 5GS when the UE moves from EPS to 5GS, or need for updating UE policy as follows:
For the case of initial registration and registration with 5GS when the UE moves from EPS to 5GS, the PCF compares the list of PSIs included in the UE policy information in Npcf_UEPolicyControl_Create request and determines whether UE policy information have to be updated and be provided to the UE via the AMF using DL NAS TRANSPORT message; and
For the network triggered UE policy update case (e.g. the change of UE location, the change of Subscribed S-NSSAIs), the PCF checks the latest list of PSIs to decide which UE policies have to be sent to the UE.

The PCF checks if the size of the resulting UE policy information exceeds a predefined limit:
If the size is under the limit, then UE policy information are included in a single Namf_Communication_NIN2MessageTransfer service operation as described below.
If the size exceeds the predefined limit, the PCF splits the UE policy information in smaller, logically independent UE policy information ensuring the size of each is under the predefined limit. Each UE policy information will be then sent in separated Namf_Communication_NIN2MessageTransfer service operations as described below.
NOTE: NAS messages from AMF to UE do not exceed the maximum size limit allowed in NG-RAN (PDCP layer), so the predefined size limit in PCF is related to that limitation.
1. PCF invokes Namf_Communication_NIN2MessageTransfer service operation provided by the AMF. The message includes SUPI, UE Policy Container.
2. If the UE is registered and reachable by AMF in either 3GPP access or non-3GPP access, AMF shall transfers transparently the UE Policy container to the UE via the registered and reachable access.

If the UE is registered in both 3GPP and non-3GPP accesses and reachable on both access and served by the same AMF, the AMF transfers transparently the UE Policy container to the UE via one of the accesses based on the AMF local policy.

If the UE is not reachable by AMF over both 3GPP access and non-3GPP access, the AMF reports to the PCF that the UE Policy container could not be delivered to the UE using Namf_Communication_NIN2TransferFailureNotification.

If AMF decides to transfer transparently the UE Policy container to the UE via 3GPP access, e.g. the UE is registered and reachable by AMF in 3GPP access only, or if the UE is registered and reachable by AMF in both 3GPP and non-3GPP accesses served by the same AMF and the AMF decides to transfer transparently the UE Policy container to the UE via 3GPP access based on local policy, and the UE is in CM-IDLE and reachable by AMF in 3GPP access, the AMF starts the paging procedure by sending a Paging message. Upon reception of paging request, the UE shall initiate the UE Triggered Service Request procedure.
3. If the UE is in CM-CONNECTED over 3GPP access or non-3GPP access, the AMF transfers transparently the UE Policy container (UE policy information) received from the PCF to the UE. The UE Policy container includes the list of Policy Sections as described in TS 23.503.
4. The UE updates the UE policy provided by the PCF and sends the result to the AMF.
5. If the AMF received the UE Policy container and the PCF subscribed to be notified of the reception of the UE Policy container then the AMF forwards the response of the UE to the PCF using Namf_Communication_N1MessageNotify.

The PCF maintains the latest list of PSIs delivered to the UE and updates the latest list of PSIs in the UDR by invoking Nudr_DM_Update (SUPI, Policy Data, Policy Set Entry, updated PSI data) service operation.

If the PCF is notified about UE Policy delivery failure from the AMF, the PCF may initiate UE Policy Association Modification procedure to provide a new trigger “Connectivity state changes” in Policy Control Request Trigger of UE Policy Association to AMF. The PCF may re-initiate the UE Configuration Update procedure for transparent UE Policy delivery as in step 1 when the PCF is notified of the UE connectivity state changed to CONNECTED.

The 3GPP standard also describes a PCF that provides Session Management related functionality referred to as PCF for PDU session or SM-PCF, interacting with a PCF that provides non-session management functionality referred to as PCF for a UE or (UE-PCF). The interactions between UE-PCF and SM-PCF for a PDU Session are described by Npcf services which enables reporting of PDU Session related events detected by the SM-PCF for a PDU Session to the UE-PCF. The reported events include reporting for example the start and stop of application traffic detection within the PDU session.

3GPP Technical Report (TR) 23.700-85 v0.2.0 describes a number of issues including Key Issue #3 related to Provisioning consistent URSP to UE across 5GS and EPS. More specifically, the UE may use the route selection component (e.g., DNN) in a URSP rule in EPS, but when the URSP rule is updated at network side, there is no way to provision the URSP rule to UE in EPS based on current design. The TR 23.700-85 v0.2.0 further documented a solution (Solution #16) to address the Key Issue #3 where the solution proposes a mechanism that allows the network (PCF) to update the URSPs for a UE in EPS, by encapsulating UPDP messages into a new information element (UE policy container) and transmitting it to an SMF+PGW-C. The SMF−PGW-C transmits it to the UE in the UE policy container ePCO by using existing procedure of PDN GW initiated bearer modification without bearer QoS update over the EPS.

When the UE in EPS needs to send a UPDP message towards the PCF in relation to UE Policy handling the UE first encapsulates the UPDP message into a UE Policy Container ePCO and then transfers it towards the SMF+PGW-C by reusing existing mechanisms. When the SMF+PGW-C receives such UE Policy Container ePCO from the UE, just forwards transparently the UE Policy Container towards the PCF by reusing SMF initiated SM Policy Association procedure (establishment or modification).

TR 23.700-85 v0.2.0 documented another Solution #20 to address Key Issue #3. Solution #20 proposes an interface between the UE-PCF and the SM-PCF to forward the UE Policy (including the list of PSI, and URSP), and the acknowledgement on UE reception of UE Policy. However, that solution leaves for further study how to handle UE Policy Associations when the UE moves from 5GS to EPS and how the UE-PCF is addressed.

The key points of the solution #20 are as follows:
The UE in EPS initiates the UE Policy delivery from the network. When the UE has the list of PSIs, the UE includes the list of PSIs into the UE Policy Container, and includes the UE Policy Container to PCO. The UE sends this PCO to the SMF+PGW-C during the Initial Attach procedure, as described in clause 5.3.2.1 of TS 23.401.
The SMF+PGW-C invokes Npcf_SMPolicyControl_Update Request to the SM-PCF to transfer the UE Policy Container received from the UE to the UE-PCF, and to retrieve the latest PSIs from the UE-PCF.
The SM-PCF establishes the UE-PCF Association with the UE-PCF which is identified UE-PCF ID received from the SMF+PGW-C.
The UE-PCF gets policy subscription related information and the latest list of PSIs from the UDR and creates the UE policy container including UE policy information as defined in clause 6.6 of TS 23.503. UE-PCF decides to provide the created UE policy container to the UE.
When the UE-PCF decides to provide the latest or updated list of PSIs to the UE, the UE-PCF provides to SM-PCF the UE Policy Container, and the SM-PCF forwards it to the SMF+PGW-C.
The SMF+PGW-C includes the UE Policy Container within the PCO, and delivers to the UE. When the UE Policy delivery is initiated by the UE, the Initial Attach procedure (described in clause 5.3.2.1 of TS 23.401) is used. When the UE Policy delivery is initiated by the UE-PCF, the PDN GW initiated bearer modification without bearer QoS update procedure (specified in clause 5.4.3 of TS 23.401) is used.

The report does not describe whether and how to handle the UE Policy Association established in 5GS when the UE moves to EPS. When the established PDU Session is moved to EPS, and if the same UE-PCF needs to be selected (e.g. when the UE-PCF was notified about UE policy information delivery failure in 5GS described in TS 23.503), whether to terminate or not terminate the UE Policy Association and whether/how to receive PCF Selection Assistance Info and UE-PCF ID from the UDM.

### SUMMARY

There currently exist certain challenge(s). As described in the TR 23.700-85 v0.2.0, the UE-PCF and the SM-PCF may be deployed as separate entities. In chapter 2.1.5 of the TR, a solution is described to establish an association between the SM-PCF and the UE-PCF when UE initially attaches to the EPC, and how this association is used for the purpose of delivery of UE policies (e.g., URSP) updates to the UE in EPC. However, the solution in chapter 2.1.5 does not apply to UE mobility from 5GS to EPS. Note that EPS and EPC are used interchangeably henceforth acknowledging that an EPS includes an EPC and the EUTRAN.

When a UE moves from 5GS to EPS, if URSP updates needs to be delivered to the UE in EPS, the SM-PCF and the UE-PCF needs to interact for the purpose of sending updated UE policies to the UE over the EPS. Embodiments described herein provide a solution for providing UE policies (e.g., URSP) updates to the UE when the UE moves from a first system to a second system using an interworking session management function. The embodiments henceforth are described using 5GS as a first system and EPS and a second system, both systems are interworking. However, it will be understood to a person skilled in the art that the first and second system could be any other systems, e.g., 6G system and beyond.

In 5GS, when the UE-PCF and the SM-PCF are deployed as separate entities necessitate the establishment of a UE Policy Association between the SM-PCF and the UE-PCF.

Embodiments are proposed where the SM-PCF is a consumer of the Npcf_UEPolicyControl service provided by the UE-PCF for the purpose of providing the UE policies (e.g., URSP updates to the UE in the EPS). When the SMF+PGW-C(the interworking session management controller) notifies the SM-PCF that the UE is moved from 5GS to EPS, the SM-PCF triggers the establishment of a UE Policy Association towards the UE-PCF.

A method performed by a policy control function (PCF) for a User Equipment (UE) (UE-PCF) for updating UE policies at the UE is provided. The method comprises receiving by the UE-PCF from an Access Mobility Function (AMF) in a first system a request to delete the UE policy association it has previously established with the UE-PCF (e.g., at UE Registration in 5GS). The request to delete the association includes first information indicating the UE has moved from the first system to a second system. The UE-PCF maintaining the UE policies associated to the UE policy association for a configurable time period; before the time expires, receiving from a PCF for a Packet Data Unit (PDU) session (SM-PCF) a request to establish a policy association, the request includes an empty UE Policy Container and an indication of a handover of the UE to the second system. Then, based on the indication of the handover (e.g., 5GS to EPS handover) of the UE to the second system, the UE-PCF associates the maintained UE policies to the newly established policy association with the SM-PCF and determines whether the UE policies need to be updated at the UE over the second system by for example re-evaluating the UE policies based on the type of policies that can be supported, allowed on the second system.

According to an embodiment, the method at the UE-PCF further comprises in the event of multiple UE policy associations established from different SM-PCF towards the UE-PCF, the UE-PCF selecting a UE policy association that includes the indication of UE handover from the first system to the second system. The method then comprises the step of the UE-PCF generating the UE policies and sending the UE policies over the selected UE policy association for delivery to the UE in the second system.

In some examples, the UE policies may be Access network discovery & selection policies (ANDSP) and/or UE Route Selection Policies (URSP) and/or Vehicle to anything (V2X) Policies and/or proximity (ProSe) Policies (ProSeP) and/or whatever future policies that needs to be provisioned, updated with the UE.

In accordance with some embodiments a method performed by a user equipment (UE) for obtaining UE policies updates when moving from a first system to a second system is provided. The method comprises sending a Registration Request message to a network node to register in a first system (AMF in 5GS) and sending information to the first system indicating the UE supports UE policies updating over a second system. The information may be included in the Registration message or in a separate message.

In some examples, the information is included in a UE policy container or as an information element of the Registration Request message.

In some examples, the method further comprises the UE moving to the second system (EPS) and receiving the UE policies over the second system in response to the UE having indicated the UE policies can be updated over the second system.

In accordance with some examples, A UE comprising a processing circuitry and a memory coupled with the processing circuitry, wherein the memory includes instructions that when executed by the processing circuitry causes the UE to perform any one of the embodiments described herein. In another example, a UE can be adapted to perform any one of the embodiments described herein.

In accordance with some embodiments, a method performed by a Policy Control Function (PCF) for a Packet Data Unit (PDU) session (SM-PCF) for updating UE policies for a UE performing handover from a first system to a second system is provided. The method comprises receiving a notification from a PDU session controller for a UE, the notification indicating the UE has performed a handover from the first system to the second system and may include an empty UE policy container. In response to determining a UE policy association should be established for the UE, sending a request to the UE-PCF that served the UE in the first system to establish the UE policy association, the request including an indication of UE handover to the second system.

In some examples, the method further comprises discovering the UE-PCF for the UE using a binding function that maintains an association between the UE-PCF and the UE.

In some examples, The method comprises obtaining from a User Data repository information indicating whether or not the UE supports or prefer to receive UE policies over the second system. If information indicates the UE does not support or not prefer to receive UE policies over the second system, the SM-PCF refraining from establishing the UE poly association with the UE-PCF.

In some examples, the method further comprises the SM-PCF receiving a second notification from the PDU session controller for the UE (SMF+PGW-C), the notification indicating the UE has moved back to the first system and sending a request to cancel the policy association with the UE-PCF to delete the established UE policy association between the SM-PCF and the UE-PCF.

In some examples, a first network node in a communications system comprises a processing circuitry and memory coupled with the processing circuitry, wherein the memory includes instructions that when executed by the processing circuitry causes the first network node to perform any one of embodiments of the UE-PCF or SM-PCF as described herein.

In some examples, a computer program comprising program code to be executed by processing circuitry of a first network node in a communication system, whereby execution of the program code causes the first network node to perform any one of the embodiments of the UE-PCF or SM-PCF as described herein.

According to some embodiments, unnecessary signaling is avoided when the wireless device/UE moves from 5GS to EPS, i.e., the signaling produced by the deletion of former UE Policy Association (5GS) initiated from AMF and creation of a new UE Policy Association from the SM-PCF. The unnecessary signaling refers to the un-binding and immediate binding from BSF in addition to un-subscription and immediate subscription from UDR when the wireless device/UE moves from 5GS to EPS.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram depicting an example of a wireless communication system (5GS);

FIG. 2 is a block diagram depicting the service based architecture of the system in FIG. 1;

FIG. 3 is a block diagram depicting interworking between 5GS and EPS;

FIG. 4 illustrates a prior art flow diagram of a UE configuration procedure for configuring UE policies;

FIG. 5 is a signaling diagram illustrating SM-PCF establishing a UE Policy Association towards UE-PCF when UE moves from 5GS to EPC in accordance with some embodiments of the present disclosure;

FIG. 6A is a signaling diagram illustrating a wireless device/UE managing the UE policies updates in accordance with some embodiments of the present disclosure;

FIG. 6B is a signaling diagram illustrating URSP updates delivery over EPS at UE mobility from 5GS to EPS in accordance with some embodiments of the present disclosure;

FIG. 7 is a flow chart illustrating operations of a UE in accordance with some embodiments of the present disclosure;

FIG. 8A is a flow chart illustrating operations of a UE-PCF in accordance with some embodiments of the present disclosure;

FIG. 8B is a flow chart illustrating operations of a SM-PCF in accordance with some embodiments of the present disclosure;

FIG. 9 is a block diagram of a communication system in accordance with some embodiments;

FIG. 10 is a block diagram of a UE in accordance with some embodiments;

FIG. 11 is a block diagram of a network node in accordance with some embodiments;

FIG. 12 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node/server/distributed servers/dedicated platform that implements one or more core network function also referred to as Network Function. Some examples of Network Function include, e.g., a Mobility Management Entity (MME), a Packet Data Network Gateway (P-GW), a Service Capability Exposure Function (SCEF), a Home Subscriber Server (HSS), or the like in EPS. Some other examples of a Network Function include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), SMF+PGW controller or the like in 5GS or other future systems such as 6G and beyond. In general, a network function can be implemented either as a network element on a dedicated hardware, as a software instance running on a dedicated hardware, or as a virtualised function instantiated on an appropriate platform, e.g. on a cloud infrastructure.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection. The wireless communication device, wireless device and UE are used interchangeable and UE is used henceforth to indicate any of them.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

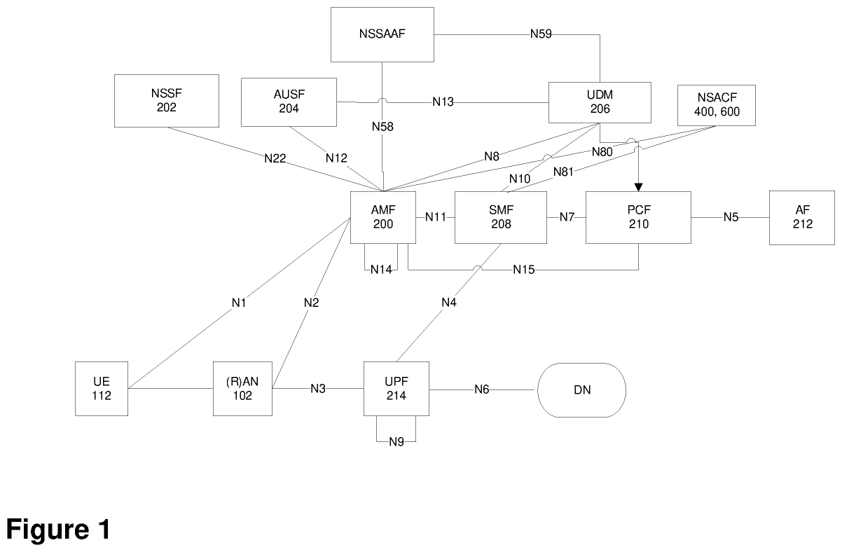

FIG. 1 illustrates a wireless communication system represented as a 5GS composed of core Network Functions (NFs), where interaction between any two NFs is represented by a point-to-point reference point/interface.

Seen from the access side the 5GS shown in FIG. 1 comprises a plurality of UEs 112 connected to either a RAN 102 or an Access Network (AN) as well as an AMF 200. Typically, the R (AN) 102 comprises base stations, e.g. such as eNBs or gNBs or similar. The 5GS consists of a 5G core network (5GC) a (R) AN and UE(s). Seen from the core network side, the 5GC NFs shown in FIG. 1 include a NSSF 202, an AUSF 204, a UDM 206, the AMF 200, a SMF 208, a PCF 210, an NSACF (400) and an Application Function (AF) 212.

Reference point representations of the 5GS are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208. The Network Slice Admission Control (NSACF 400, 600) uses reference points N81 and N80 towards the SMF 208 and AMF 200 respectively for slice admission control at registration and PDU session establishment.

The 5GC network aims at separating UP and CP. The UP carries user traffic while the CP carries signaling in the network. In FIG. 1, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The 5GC is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

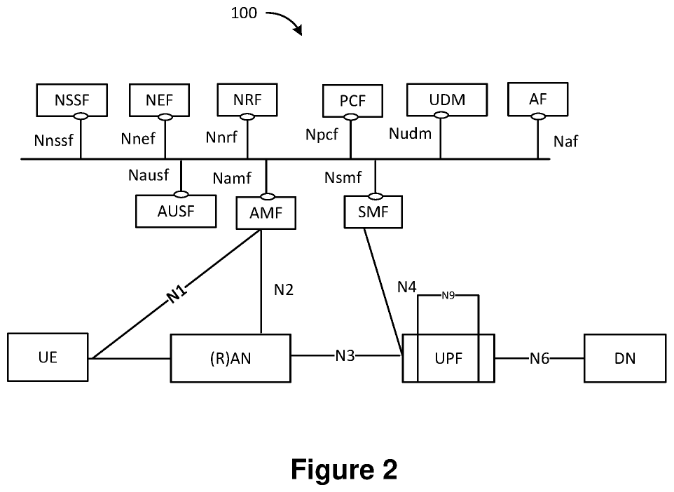

FIG. 2 illustrates a 5GS using service-based interfaces between the NFs in the CP, instead of the point-to-point reference points/interfaces used in the 5G network architecture of FIG. 1. However, the NFs described above with reference to FIG. 1 correspond to the NFs shown in FIG. 2. The service(s) etc. that a NF provides to other authorized NFs can be exposed to the authorized NFs through the service-based interface. In FIG. 1 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 2 are not shown in FIG. 2 discussed above. However, it should be clarified that all NFs depicted in FIG. 1 can interact with the NEF 300 and the NRF 302 of FIG. 2 as necessary, though not explicitly indicated in FIG. 1.

Some properties of the NFs shown in FIGS. 1 and 2 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar. The Network Slice Admission Control Function (NSACF 400) monitors and controls the number of registered UEs per network slice and/or the number of PDU Sessions per network slice for the network slices that are subject to Network Slice Admission Control (NSAC).

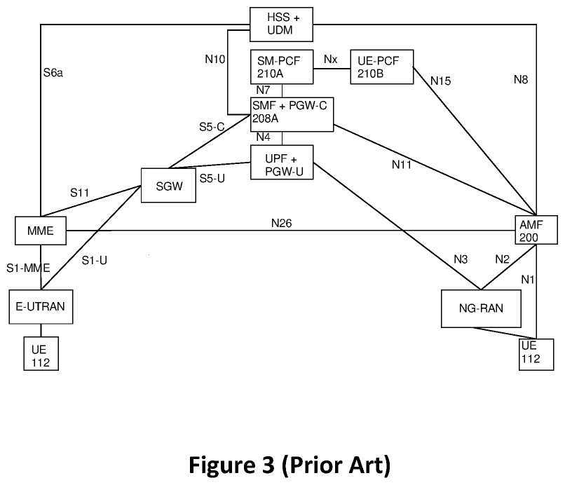

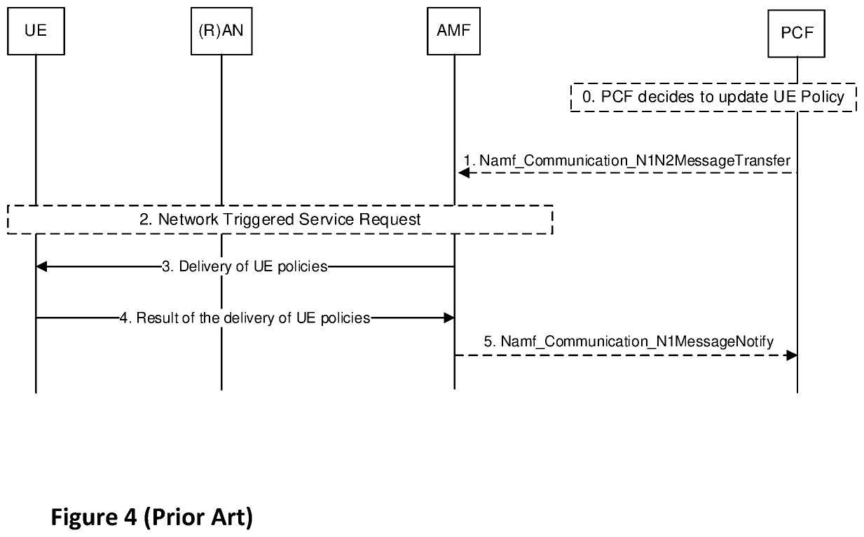

FIG. 3 illustrates the non-roaming architecture for interworking between 5GS and EPS (EPC/E-UTRAN) where the policy function (PCF) is split into two instances SM-PCF 210A and UE-PCF 210B.

The PCF providing session management policy control for a UE 112 (i.e. PCF for the PDU Session or SM-PCF 210A) and the PCF providing non-session management policy control for that UE (i.e. PCF for the UE or UE-PCF 210B) are illustrated as different PCF instances. The SM-PCF 210A does not support the N15 reference point towards the AMF 200 while the UE-PCF 210B does not support the N7 reference point towards the SMF+PGW-C 208A. The Nx reference point enables communication between the UE-PCF 210A and the SM-PCF 210B.

The N26 interface is an inter-CN interface between the MME in EPS and the AMF 200 in 5GS in order to enable interworking between EPS and the 5GS. The SMF+PGW-C and UPF+PGW-U 208A are dedicated for interworking between 5GS and EPS, which are optional and are based on UE MM Core Network Capability and UE subscription. UEs that are not subject to 5GS and EPS interworking may be served by entities not dedicated for interworking, i.e. by either by PGW or SMF/UPF.

Certain aspects of the present disclosure and their embodiments may provide solutions to the aforementioned or other challenges.

Embodiments described herein propose the SM-PCF 210A to be a consumer of the Npcf_UEPolicyControl service provided by the UE-PCF 210B for the purpose of providing URSP updates to the UE when the UE is in EPC or moves to EPC. When the SMF+PGW-C 208A notifies the SM-PCF 210A that the UE is in EPC or is moved to EPC, the SM-PCF 210A triggers the establishment of a UE Policy Association towards the UE-PCF 210B. Once the UE Policy Association is established between the SM-PCF 210A and the UE-PCF 210B, the UE-PCF 210B may decide at any time to send an update of a UE policy (e.g., URSP) to the UE 112 while in EPS, e.g. if triggered by an AF guidance on URSP trigger. In addition, the UE-PCF 210B is also able to provide a UE policy (e.g., URSP) update at UE Policy Association establishment request from the SM-PCF 210A. Note that the existence of a UE Policy Association for a UE 112 is a pre-requisite for the UE-PCF 210B to detect that UE policy (e.g., URSP) updates are needed to be provided for the UE 112, i.e., if there is no established UE Policy Association for a UE 112 the UE-PCF 210B cannot subscribe to receive changes from UDR for this UE 112, hence it is not able to trigger any UE policy (e.g., URSP) update due to for example new AF requests for guidance on URSP. Beyond the basic description of the solution where the SM-PCF 210A triggers the establishment of the UE Policy Association upon SMF+PGW-C 208A notification of 5GS to EPC handover or mobility of the UE, several issues need to be solved in relation with the establishment or termination of a UE Policy Association from the SM-PCF 210A:

The SM-PCF Determining that the UE Supports URSP Provisioning in EPS

When the UE registers in 5GS and the UE establishes a PDU session with the SMF+PGW-C via the AMF, the SM-PCF has no information about whether the UE supports URSP delivery in EPS, therefore the SM-PCF cannot properly determine if and when a UE Policy Association towards the UE-PCF should be established or not for that UE.

Hence, according to some embodiments, an extension of the UE Policy Container that the UE sends at 5GS initial registration is proposed. The UE may include in that extension an indication about whether the UE supports URSP delivery when in EPS. Note that EPS, 4G, EPC are similar for this purpose. The 5GS registration is sent from the UE to the AMF in 5GS, the AMF transfers the UE policy container included in the registration message to the UE-PCF. Then the UE-PCF stores the extension included in the UE policy container in the UDR for the UE during 5GS initial registration as part of UE context policy control subscription information.

When the UE moves from 5GS to EPS, the SM-PCF determines the UE supports URSP delivery in EPS by retrieving and/or checking UE context policy control subscription information in the UDR and decides whether to establish a UE Policy Association with the UE-PCF.

What if there are Multiple Ongoing PDU Sessions for the UE Handled in the Same SM-PCF?

If there are multiple ongoing PDU sessions for the UE handled by the same SM-PCF (e.g. in a deployment where the same SM-PCF handles all the PDU sessions for an S-NSSAI), the SM-PCF might trigger the establishment of a UE Policy Association per every PDU session when the SMF+PGW-C notifies the SM-PCF that UE has moved to EPS in every PDU session. This may trigger unnecessary additional signalling in the network and cause collisions if the UE-PCF initiates URSP updates over all the ongoing UE Policy Associations.

Hence, according to some embodiments, to overcome the above challenge, if there are multiple ongoing PDU sessions for the UE handled by the same SM-PCF (e.g. in a deployment where the same SM-PCF handles all the PDU sessions for an S-NSSAI), the SM-PCF controls and determines that only one UE Policy Association Establishment is established and maintained for the same UE. I.e. in case the same SM-PCF maintains several PDU sessions for the same UE the SM-PCF will establish the UE Policy

Association only for the first PDU session establishment which reports the change of RAT-Type. In addition, it is proposed the SM-PCF will terminate the UE Policy Association if the last PDU session for this UE is terminated.

Furthermore, the UE-PCF is able to send a UE policy (e.g., URSP) update to a UE which has moved from 5GS to EPC if there is at least one ongoing PDU session for the UE in the SM-PCF.

In an alternative embodiment, it may be possible to restrict the solution to work for a PDU session established over a specific (configured) combination of S-NSSAI/DNN, therefore the SM-PCF will only establish a single UE Policy Association towards the UE-PCF if the PDU session is for the specific S-NSSAI/DNN.

What if there are Multiple SM-PCFs Handling PDU Sessions for the UE?

If there are multiple SM-PCFs handling PDU sessions for the UE (e.g., one SM-PCF per S-NSSAI/DNN), every SM-PCF may establish a UE Policy Association towards the UE-PCF. With no additional handling, the UE-PCF upon receiving a trigger for UE policy (e.g., URSP) update for the UE, the UE-PCF may attempt to send to the UE the UE policy (e.g., URSP) update over the different ongoing UE Policy Associations which may cause collisions between the different UE Policy Associations.

Hence, according to some embodiments, to overcome the above challenge, an extension to the Npcf_UEPolicyControl_Create operation (between the SM-PCF and UE-PCF) is proposed and includes an indication that the trigger for the establishment of the UE Policy Association is due to a handover from 5GS to EPS. Therefore, when the SMF uses the Npcf_UEPolicyControl_Create operation to establish the UE policy association with the UE-PCF, the SM-PCF includes such indication to indicate e.g.

“Handover5GStoEPS”. When the UE-PCF receives such indication, it is able to correlate the UE Policy Associations with the indication and avoid the re-sending of URSP updates for each of the UE Policy associations.

According to some embodiment, when the UE-PCF determines an update of UE policies (e.g., URSP) is needed for a UE, the UE-PCF will select one of the UE Policy Associations for this UE for which the new indication is received and use it for the URSP update delivery.

In one embodiment, it may be possible to restrict the solution to work for a PDU session established over a specific (configured) combination of S-NSSAI/DNN, therefore only one SM-PCF (the one handling the session for the specific S-NSSAI/DNN) will establish the (single) UE Policy Association towards the UE-PCF.

According to some examples the embodiments described for multiple SM-PCFs together with embodiments for handling multiple ongoing PDU sessions can be combined to allow the UE-PCF to send a URSP update to a UE which has moved from 5GS to EPS if there is at least one ongoing PDU session for the UE in at least one SM-PCF, no matter if some PDU sessions have been terminated in some other SM-PCFs after the UE moves to EPS.

### How can the UE-PCF Get the List of PSIs Stored in the UE, Since the SM-PCF is not Providing Such Information as Part of UE Policy Association Establishment?

The following challenge is identified: when the SM-PCF, receives a notification from the SMF+PGW-C indicating that the UE has moved to EPS/EPC, the SM-PCF establishes a UE Policy Association towards the UE-PCF, the SM-PCF doesn't provide any information about the UE policies stored in the UE (i.e. the UE doesn't provide the UE STATE INDICATION UPDP message when the UE moves to EPS/EPC). Therefore, If the UE-PCF doesn't receive such information at the UE Policy association establishment, it will assume no UE policies (e.g., URSP) are stored in the UE and in this case the UE-PCF will provide the full list of applicable UE policies (e.g., applicable URSPs) to the UE, which would add unnecessary signalling in the network and over the air interface when signalling the complete policies to the UE and additional processing in the UE.

Hence, according to some embodiments, to overcome the above challenge, it is proposed the UE-PCF obtains the UE policies available at the UEfrom the former UE Policy Association for this UE which was established when the UE was in 5GS. However, for scenarios with N22, according to 3GPP TS 23.502 section 4.11.1.2.1 the AMF deletes the UE Policy Association when the UE moves to EPC and it is not clear if this deletion happens after or before the SMF+PGW-C notifies the SM-PCF about the change to EPS/EPC. So it is uncertain whether the UE-PCF deletes the ongoing UE Policy Association (from 5GS) before the new UE policy association from the SM-PCF is established for the UE connected over the EPS.

In order to avoid that the former UE Policy association from 5GS is deleted in UE-PCF before the new association from SM-PCF is established, it is proposed to extend the operation for deletion of the UE Policy Association (Npcf_UEPolicyControl_Delete) with a new indication to signal the scenario which triggers the deletion. More specially, when the AMF initiates the deletion of the UE policy association because the UE has handover from 5GS to EPC, the AMF includes the handover to EPS indication so the PCF may delay the removal of the ongoing UE Policy Association while waiting for the establishment of the new UE Policy Associations from the SM-PCF signalling the UE has now handed over to EPS.

Consequently, when the UE Policy Association from the SM-PCF is established with an empty UE Policy Container and an indication of handover, i.e., “Handover5GStoEPS” as described above, the UE-PCF can obtain the UE policies stored in the UE from the ongoing UE Policy Association established for 5GS.

In addition, when the UE-PCF delays the removal of the UE Policy Association, it is also proposed the UE-PCF delays other additional actions related with the removal of the association, e.g., delay the unbinding from the BSF or un-subscription to receive notifications from UDR, therefore unnecessary signalling due to the unbinding and immediate binding from BSF and un-subscription and immediate subscription to the UDR is avoided.

How to Discover and Select UE-PCF in Case More than One are Deployed?

According to some embodiments, it is proposed that the SM-PCF be a new consumer of Npcf_UEPolicyControl service provided by the UE-PCF, however, a solution should be provided for the discovery and selection of the UE-PCF at the SM-PCF.

Hence, according to some embodiments, to overcome the above challenge, tt is proposed, that when the SM-PCF determines that a a UE Policy Association should be established because of the UE handover from 5GS to EPC, the SM-PCF first discovers the address of the UE-PCF by querying the Binding Support Function (BSF) in the 5GS. This proposal makes it possible for the SM-PCF to select the same UE-PCF handling the UE Policy Association in 5GS, therefore the UE-PCF that receives the new UE Policy Association creation request from the SM-PCF is able to get the UE policies stored in the UE from the former UE Policy Association in 5GS.

In addition, it makes possible that in case of different SM-PCFs are handling different PDU sessions for the same UE, the SM-PCFs may select the same UE-PCF as they retrieve the UE-PCF from the BSF.

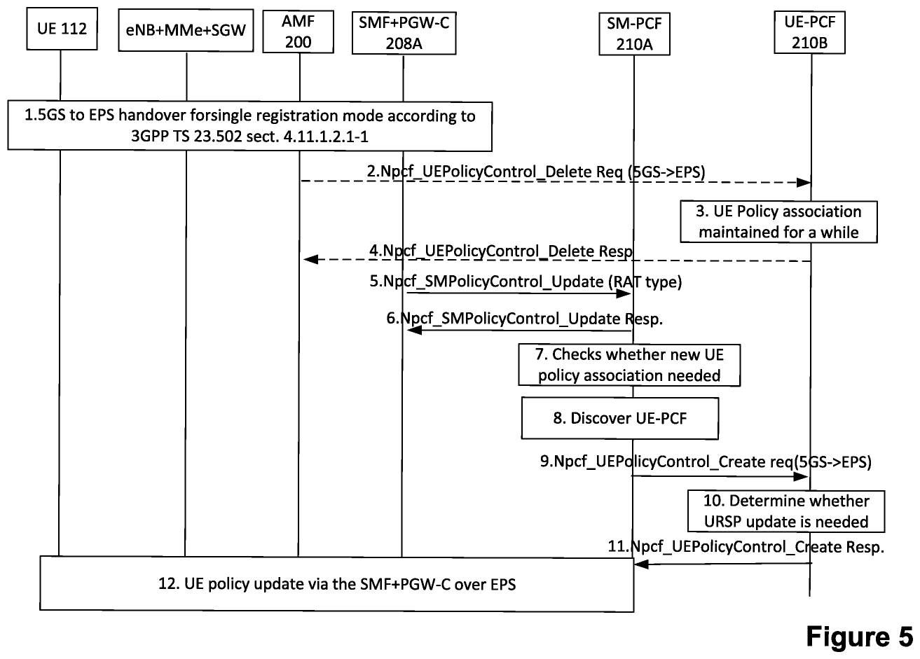

FIG. 5 is a signaling diagram illustrating an SM-PCF 210A establishing a UE Policy Association towards the UE-PCF 210B when UE 112 moves from 5GS to EPC in accordance with some embodiments described herein;

Step 1: This step is according to the standard procedure for 5GS to EPC handover as described in 3GPP TS 23.502 section 4.11.1.2.1-1 (note that this is similar for handover with idle mobility)

Step 2: For the scenarios with N26, the AMF 200 invokes the deletion of UE Policy Association including a new indication “5GS handover to EPC” at the UE-PCF, note that N26 interface is the interworking interface between an AMF 200 in 5GC and an MME in 4G EPC.

Step 3-4: Based on the proposed indication (“5GS handover to EPC”), after the UE-PCF 210B responds to the AMF 200, the UE-PCF 210B decides to maintain the UE Policy information for a configurable period (e.g. 20s), until the new UE Policy Association from the SM-PCF 210A is received. During this time period, no other actions associated to the removal of the UE Policy Association (e.g. unbinding from BSF or un-subscription from UDR notifications for this UE 112) are executed.

NOTE: If step 2 happens after step 8, the UE-PCF 210B removes immediately the former UE Policy Association.

Step 5: SMF+PGW-C 208A notifies SM-PCF 210A about the handover of the UE 112 to EPS invoking Npcf_SMPolicyControl_Update Request.

This step happens for every ongoing PDU session handled by the SM-PCF 210A.

Step 6: SM-PCF 210A answers SMF+PGW-C 208A as in the current standard procedure (TS 23.502)

Step 7. The SM-PCF 210A determines whether the UE 112 supports URSP delivery in EPC by checking UE context policy control subscription information in the UDR. For those deployments where the solution is just restricted to a specific combination of S-NSSAI/DNN (as described in Issue2 and Issue3 above) the SM-PCF 210A also checks if the PDU session being notified by SMF+PGW-C 208A is established towards the specific S-NSSAI/DNN. Based on the two conditions above the SM-PCF 210A decides whether to establish a UE Policy Association towards the UE-PCF 210B.

NOTE: For those scenarios where the solution is not restricted to a specific S-NSSAI/DNN, the SM-PCF 210A controls that only one UE Policy Association Establishment is established and maintained for the same UE. i.e. in case the same SM-PCF 210A maintains several PDU sessions for the same UE 112, the SM-PCF 210A will establish the UE Policy Association only for the first PDU session establishment which reports the change of RAT-Type (i.e., 4G RAT type when moving to EPS)

Step 8: The SM-PCF 210A discovers the address of the UE-PCF 210B handling the UE by querying the BSF.

Step 9: The SM-PCF 210A establishes a UE Policy Association towards the UE-PCF 210B including an empty UE Policy Container, i.e. no information about PSI list in the UE 112 is provided to the UE-PCF 210B and an indication indicating that the trigger for the UE Policy association establishment is handover to EPS or 4G (“5GS to EPC handover”). Based on that new indication, the UE-PCF 210B recovers the information about the PSI list in the UE 112 from former UE Policy Association for the UE 112.

Note: If the UE policy information associated with the former UE Policy Association is not yet deleted, the UE-PCF 210B can now delete it. Since additional UE Policy Associations are still ongoing for this UE (the one from SM-PCF 210A), the UE-PCF 210B doesn't execute other additional actions associated to the removal of the UE Policy Association (e.g. unbinding from BSF or un-subscription from UDR notifications for this UE 112).

Step 10: The UE-PCF 210B determines whether an update of URSP is needed (due to the UE moving to EPS) by re-evaluating applicable URSPs for the UE 112 and comparing with the list of PSIs stored in the UE 112.

Step 11: the UE-PCF 210B sends Npcf_UEPolicyControl create answer including a UE Policy Container with the URSP updated if needed.

Step 12: The UE 112 policies are transmitted from the SM-PCF 210A to the SMF+PGW-C 208A for transfer to the UE 112 using bearer modification procedure in EPS, where the UE policies are for example included in an ePCO information element.

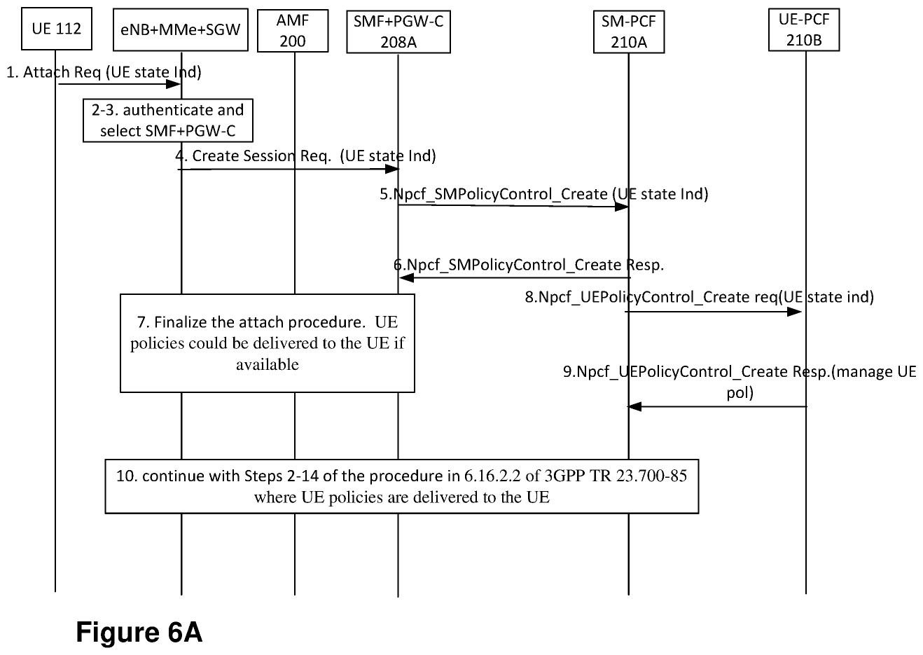

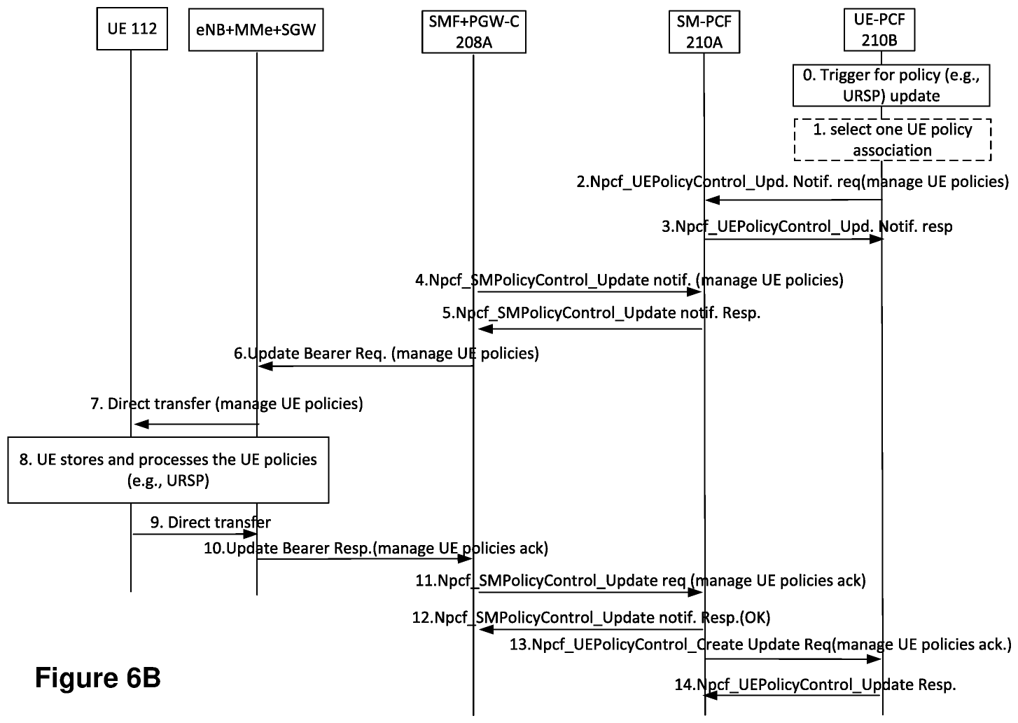

FIG. 6A is a signaling diagram illustrating an attach procedure in EPS in deployments where the PCF for the PDU session (SM-PCF 210A) and the PCF for the UE (UE-PCF 210B) are different PCFs.

The signaling diagram is based and extends the procedure described in 6.16.2.1 of TR 23.700-85 when the PCF for a PDU session is different than the PCF for a UE

Steps 1-7: are the same steps described for deployments with a collocated PCF as described in section 6.16.2.1 of TR 23.700-85, with the difference that in step 5 the SMF+PGW-C 208A selects a PCF for a PDU session (SM-PCF 210A). Mainly step 1 describes a UE 112 attaching to EPS including an indicator that it is able to receive UE policy updates over EPS. Steps 2 and 3 is as per current art where the MME in EPS authenticates the UE and selects an SGW and an SMF+PGW-C 208A. Step 4 the SGW sends a Create Session Reqquest to the selected SMF+PGW-C 208A including the indicator from the UE 112.

At step 5, the SMF+PGW-C 208A selects an SM-PCF 210A to create an SM policy and includes the indicator. The SM-PCF 210A sends a response at step 6 to indicate that it accepts the establishment of the SM policy. At step 7, the SMF+PGW-C 208A, the eNB+MME+SGW and the UE 112 finalize the Attach procedure and establishment of the session with the UE. At this time, the SMF−PGW-C 208A will send the UE policies (e.g., URSP) in an ePCO to the UE 112 if it has received them from the SM-PCF 210A.

Step 8 (can be performed before step 6): The SM-PCF 210A checks whether the SMF+PGW-C 208A provided a UE Policy Container in step 5 and then establishes a UE Policy Association with the UE-PCF 210B providing the UE Policy Container received from the SMF+PGW-C 208A.

Step 9: The UE-PCF 210B follows standard procedure to handle the UE Policy establishment as defined in TS 23.502 section 4.16.11 for the roaming case. If the UE-PCF 210B determines that a UE policy (e.g., URSP) update with the UE 112 is needed, it provides a UE Policy Container including the UE policy (e.g., URSP) update to the SM-PCF 210A when sending the response to the UE Policy Association establishment request.

Step 10: If a UE Policy Container is provided to the SM-PCF 210A in step 9, the flow continues with steps 2-14 from procedure defined in section 6.16.2.2 of 3GPP TR 23.700-85 for deployments with a collocated PCF, where the updated policies are provided to the UE 112.

FIG. 6B is a signaling diagram illustrating UE policy (e.g., URSP) updates delivery over EPS initiated by a UE-PCF 210B towards a UE 112 in EPC, e.g., for the case where an AF makes a request for AF guidance on e.g., URSP.

The embodiments consider that one or several UE Policy Associations were already established between one or several SM-PCFs 210A and a UE-PCF 210B at the time of 5GS to EPS handover as described in the embodiment illustrated in for example FIG. 5. For the case where the solution is restricted to a specific S-NSSAI/DNN there will be just one UE Policy Association established from one SM-PCF 210A.

The interactions between the SM-PCF 210A and the SMF+PGW-C 208A (illustrated in FIG. 3) are based on the ones already defined in Solution #16 of TR 23.700-85 v0.2.0, as described in the background section, for UE policies (URSPs) update initiated by a PCF in a deployment with a collocated PCF. The steps of FIG. 6B are described below.

Step 0: An event which triggers the re-evaluation of applicable URSP (as an example of UE policies) for a UE 112 has occurs at the UE-PCF 210B (e.g. a notification from UDR about a new AF request for AF guidance on URSP). The UE-PCF 210B determines that an update of URSP is needed for the UE 112.

Step 1: In case several ongoing UE Policy Associations with new indication “5GS to EPC handover” exists in the UE-PCF 210B, the UE-PCF 210B selects one of them for the delivery of the URSP update. For the case where the solution is restricted to a specific S-NSSAI/DNN there will be just one UE Policy Association as explained above

Step 2: The UE-PCF 210B generates the corresponding UE Policy Container (UPDP message MANAGE UE POLICY COMMAND) in a similar way as done in 5GC and invokes Npcf_UEPolicyControl_UpdateNotify with the SM-PCF and includes the UE Policy Container.

Step 3: The SM-PCF 210A responds to the Npcf_UEPolicyControl_UpdateNotify

Step 4: The SM-PCF 210A triggers in the SMF+PGW-C 208A a session modification procedure in the EPC (e.g., Update Bearer or modify bearer procedure) by sending an appropriate notification or request. The SM-PCF 210A provides to the SMF+PGW-C 208A the UE Policy Container received from the UE-PCF 210B.

Steps 5-12: follows the same steps as steps 5-12 of section 6.16.2.2 in TR 23.700-85 v0.2.0 for URSPs update for a deployment with a collocated PCF.

Step 13: The SM-PCF 210A notifies the UE-PCF 210B by sending Npcf_UEPolicyControl_Update to the UE-PCF 210B to provide the received UE Policy Container that includes for e.g., MANAGE UE POLICY COMMAND COMPLETE UPDP message from the UE 112.

Step 16: The UE-PCF 210B processes the MANAGE UE POLICY COMMAND COMPLETE in a similar way than in 5GC as defined in TS 29.525 and stops timer T3501.

Step 17: The UE-PCF 210B answers Npcf_UEPolicyControl_Update request.

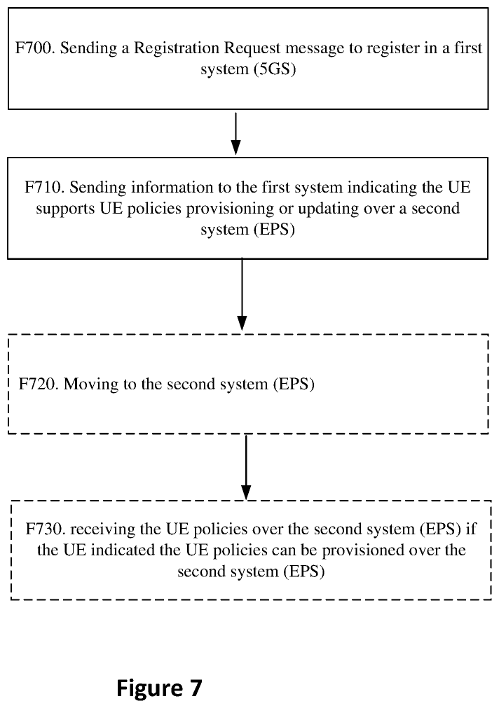

FIG. 7 illustrates a method in a wireless device (aka. UE) controlling delivery of the UE policies (e.g., URSP) when moving from a first system (e.g., 5GS) to a second system (e.g., EPS). The method comprises the step F700 of sending a Registration Request message to register when in the first system (5GS). The Registration request is transmitted to for example an AMF in 5GS. The method further comprises the step F710 of sending information to the first system (5GS) information indicating the UE supports UE policies provisioning in a second system (e.g., EPS). The first system and second system are different systems and may not be limited to 5GS and EPS, but can be extended to 6GS and 5GS or 6GS or 4GS. The information in step F710 may be included in the Registration Request message of F700 as an additional information element, or it may be included in a UE policy container transmitted over NAS in the first system (5GS). The UE policy container is transmitted over NAS to the AMF, which is then forwarded to the PCF (e.g., UE-PCF). The method further comprises the step F720 of after being registered to 5GS and possibly establishing one or more PDU sessions in 5GS, moving to the second system (EPS) (moving here implies idle mobility or connected mobility) and step F730 if the UE had previously provided the information that it can receive UE policies update in the second system (EPS) and the network node, e.g., PCF (UE-PCF) determined that UE policies should be updated, the UE receiving the UE policies over the second system (EPS)

The UE policies comprise USRP, or other policies, such as ANDSP, V2X policies, etc. as defined in 3GPP standard TS 23.503.

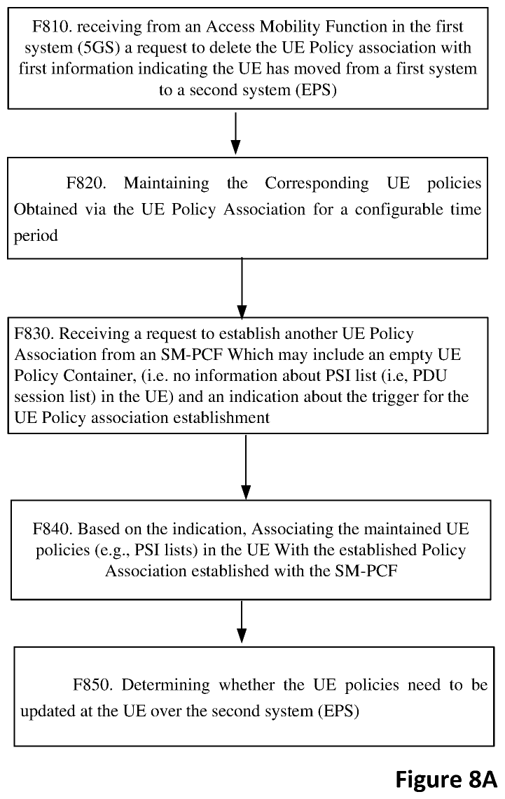

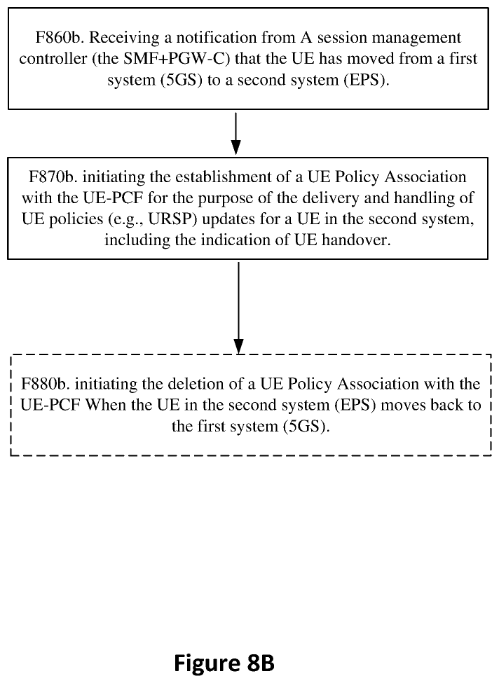

FIG. 8A shows an example of a method in a UE-PCF in accordance with some embodiments. The method comprises A method performed by a policy control function for the UE (UE-PCF) for updating UE policies, the method comprising:

Step F810: the UE-PCF receiving from an Access Mobility Function (AMF) in the first system (e.g., 5G system, 5GS) a request to delete the UE policies with first information indicating the UE has moved from a first system to a second system. When the AMF determines that the UE has moved.

Prior to step F810, in some examples, the UE-PCF receives a UE policy container from the UE via the AMF at UE initial registration over the first system (5GS), the UE policy container includes an extension that indicates whether the UE supports URSP delivery when in the second system (EPC). The UE-PCF stores the indication in the UDR for the UE as part of UE context policy control subscription information.

Step F820: The UE-PCF maintaining the UE policies for a configurable time period. The UE policies that are maintained correspond to the UE policies that have been generated or used when the UE was in the first system (5GS). Some of the UE policies might include an indication that the UE policies can be updated at the UE over a second system (e.g., EPS) if the UE handover from the first system (5GS) to the second system (EPS). The UE includes the indication that it is able to receive or send UE policy updates over the second system (EPS). The UE-PCF stores and uses the indication to control triggering the updating of UE policies to the UEs that have moved to the second system (EPS). In some examples, if the UEs have not indicated support or preference for receiving updated policies while visiting in the second system, the UE-PCF may not trigger UE policies updating when the UE is in the second system. The indication may be signaled by the UE as part of the UE policy container in a registration request message. Alternatively, the capability of the UE to receive updated policies over the second system may be obtained by the UE-PCF from another network function in the 5GS (e.g., UDM/UDR as part of subscription data directly or indirectly via the SM-PCF, i.e., the SM-PCF may retrieve the information from for example the UDM/UDR and provides it to the UE-PCF as part of the UE Policy Association establishment.

Step F830: the UE-PCF receiving from an SM-PCF a request to establish a UE Policy Association either including an empty UE Policy Container or no UE policy container is included and including an indication that the trigger for the UE Policy Association establishment is a handover of the UE from the first system (5GS) to the second system (EPS). The SM-PCF is the one contacted by the SMF+PGW-C when the UE has moved and reconnected to the second system, e.g., at Packet Data Network (PDN) connection establishment over EPS).

Step F840: based on the indication of the handover from the first system (5GS) to the second system (EPS) received from the SM-PCF, the UE-PCF performs an association of the maintained UE policies, i.e., PSI lists in the UE (from the former one or more UE policy associations established for the UE when in the first system) with the established Policy Association with the SM-PCF. In some examples, the maintained UE policies include the indication that the UE can receive the updated UE policies over the second system (EPS).

In some examples, the UE-PCF determining whether the UE policies need to be updated at the UE over the second system (EPS) based on matching the stored indication in the UE policies (previously received by the UE when in the first system) and the indication that indicates the trigger for the UE Policy Association received from the SM-PCF. If they match, i.e., the stored indication in the UE policies indicate UE can receive updated policies when in second system and the indication received from the SM-PCF indicates handover to EPS from 5GS, the UE-PCF determines it can update the UE policies in the second system. In some examples, the UE-PCF determines an update of UE policies is needed by for e.g., re-evaluating applicable UE policies for the UE when the UE is in the second system.

For example, the indication of the trigger indicated by the SM-PCF at the UE Policy association establishment may for example indicate “5GS to EPC handover”.

According to some examples, the method further comprises the step of selecting by the UE-PCF a UE policy association that includes the indication of UE handover from first system to second system handover, at which point, the UE-PCF generates the UE policies and sending the UE policies over the selected UE policy association for delivery to the UE in the second system.

Step F850. Once the UE Policy Association is established between the SM-PCF and the UE-PCF, the UE-PCF may decide at any time to send an update of UE policies (e.g., URSPs) to the UE in the second system (EPS), e.g. triggered by an AF guidance on URSP trigger.

In some examples, the UE-PCF is also able to provide a UE policy (URSP) update when a UE Policy Association is established with the UE-PCF by an SM-PCF triggered by an initial attach of the UE in the second system (EPS).

FIG. 8B illustrates a flow chart of a method performed by a PCF for a PDU session (SM-PCF). The SM-PCF is a new consumer of the Npcf_UEPolicyControl service provided by the UE-PCF for the purpose of providing URSP updates to the UE in EPC.

The method comprises the step F860b where the SM-PCF receives a notification from a session management controller that supports interworking between a first system (5GS) and a second system (EPS), the SMF+PGW-C, notifying that the UE has moved from the first system (5GS) to the second system (EPS). The method includes step F870b of initiating the establishment of a UE Policy Association with the UE-PCF for the purpose of the delivery and handling of UE policies (e.g., URSP) updates for a UE in the second system (EPS). Therefore, the SM-PCF is responsible to transfer UE Policy Containers received from the UE over N7 (FIG. 3) towards the UE-PCF, to receive those UE Policy Containers from the UE-PCF and to transfer them towards the UE via SMF+PGW-C using N7 procedures (as defined in the 5GS, see FIG. 3).

According to some examples, when the SM-PCF establishes the UE policy association with the UE-PCF, it uses the Npcf_UEPolicyControl_Create operation and includes an extension that include an indication about whether the establishment of the UE Policy Association is due to a handover from 5GS to EPC. The indication may be for e.g. “Handover5GtoEPC”.

In some examples, when the SM-PCF needs to establish a UE Policy Association triggered by a 5GS to EPC handover, the SM-PCF first discovers the address of the UE-PCF by querying the BSF. This makes it possible for the SM-PCF to select the same UE-PCF handling the UE Policy Association in 5GS, therefore the UE-PCF that receives the new UE Policy Association from the SM-PCF is able to get the UE policies (list of PSIs) stored in the UE from the former UE Policy Association in 5GS. Furthermore, it makes it possible that in case of different SM-PCFs are used to handle PDU sessions for the same UE, the same UE-PCF would be selected by all of the SM-PCFs as the BSF would provide the same.

According to some examples, when the SM-PCF is notified the UE moved to EPC, the SM-PCF determines the UE supports URSP delivery in EPC by checking UE context policy control subscription information in UDR (previously stored by the UE-PCF) and decides whether to establish a UE Policy Association.

According to some examples, if there are multiple ongoing PDU sessions for the UE handled in the same SM-PCF (e.g. in a deployment where the same SM-PCF handles all the PDU sessions for an S-NSSAI), the SM-PCF determines that only one UE Policy Association is established and maintained for the same UE, i.e. in case the same SM-PCF maintains several PDU sessions for the same UE, the SM-PCF will establish the UE Policy Association only for the first PDU session establishment which reports the change of RAT-Type. In another example, it is proposed the SM-PCF will terminate the UE Policy Association if the last PDU session for this UE is terminated.

According to an example, if and when the UE moves back (step F880b) from EPS to 5GS, the SM-PCF terminates any ongoing UE Policy Association established towards the UE-PCF when it is notified from the SMF+PGW-C that the UE has moved to 5GS (back from EPS).

According to an example, for the case of EPC initial attach that includes a PDU session establishment (aka PDN connection in EPC), the SM-PCF selects the UE-PCF based on the information retrieved from NRF query. The SM-PCF triggers the establishment of the UE Policy Association with the UE-PCF and provides to the UE-PCF a UE Policy Container received from the PDU session over the EPS and notified to the SM-PCF by the SMF+PGW-C.

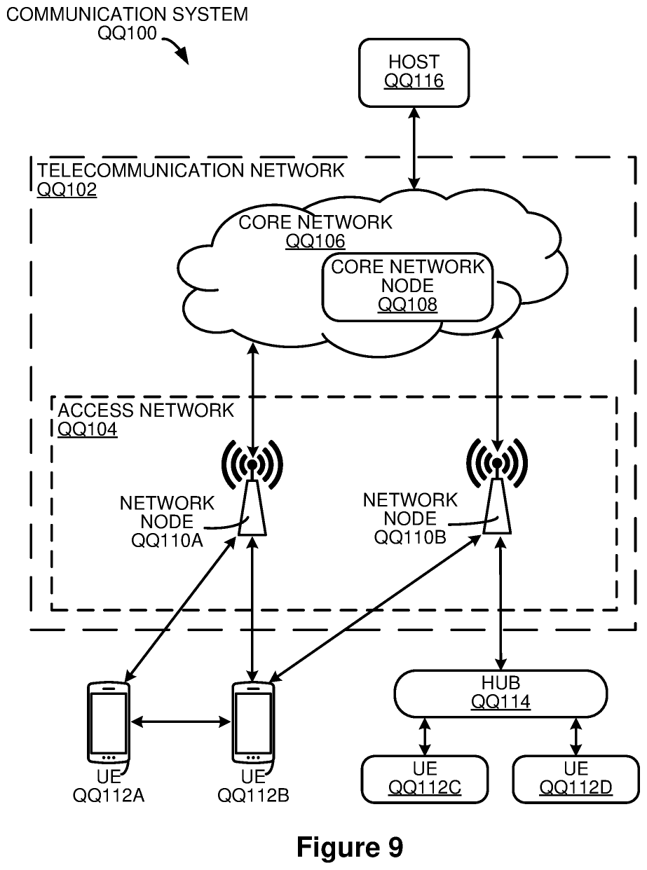

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108 (one or more of which may be generally referred to as core network nodes QQ108). The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a PCF, NWDAF, AMF, Mobile Switching Center (MSC), Mobility Management Entity (MME), Home Subscriber Server (HSS), SMF, AUSF, Subscription Identifier De-concealing function (SIDF), UDM, Security Edge Protection Proxy (SEPP), NEF, and/or a UPF.

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 y retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

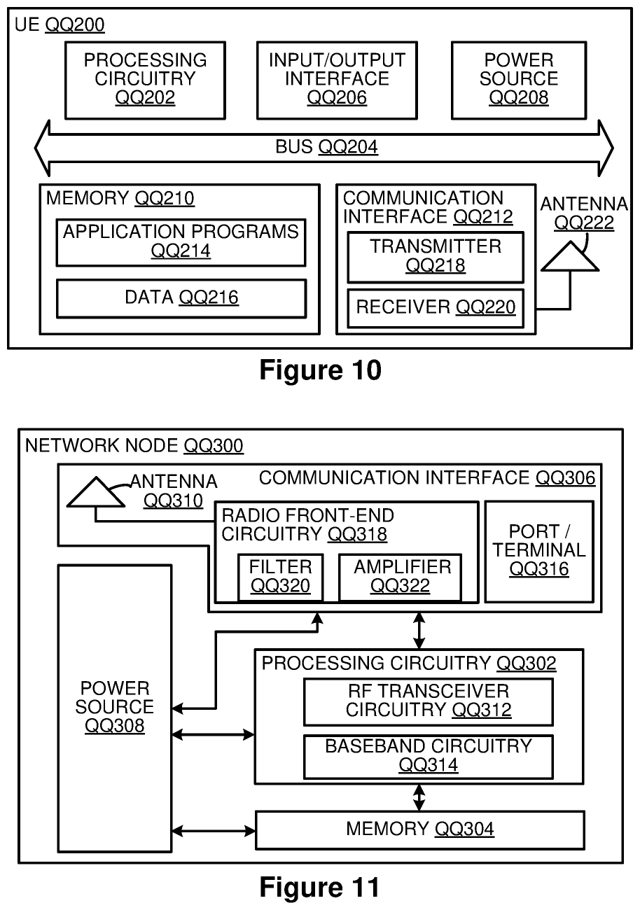

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

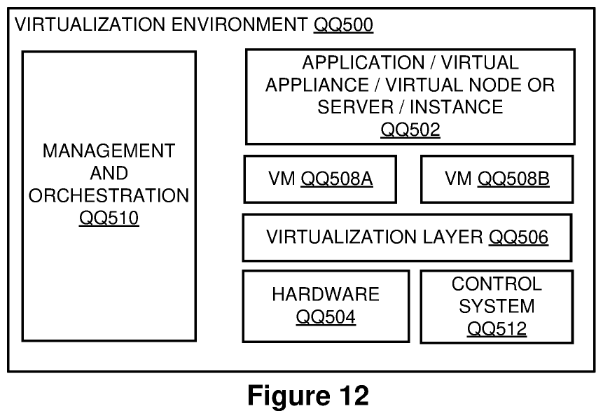

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and future protocols such as 6G and beyond.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs), 6G base stations and beyond).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, 6G, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 12 is a block diagram illustrating a virtualization environment QQ500 in which functions implemented by some embodiments may be virtualized or containerized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) or containers implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

In addition to VMs, the network functions may be deployed as one or more containers in a in a native cloud environment.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method performed by a policy control function (PCF) for a User Equipment (UE) (UE-PCF) for updating UE policies at the UE, the method comprising:
receiving from an Access Mobility Function (AMF) in a first system a request to delete the UE policy association the AMF established with the UE-PCF, the request including first information indicating the UE has moved from the first system to a second system;
maintaining UE policies associated to the UE policy association for a configurable time period;
prior to expiration of the configurable time period, receiving from a PCF for a Packet Data Unit (PDU) session (SM-PCF) a request to establish a policy association including an empty UE Policy Container, and an indication of a handover of the UE to the second system;
based on the indication of the handover of the UE to the second system, associating the maintained UE policies to the established policy association with the SM-PCF; and
determining whether the UE policies need to be updated at the UE over the second system.

2. The method of claim 1, wherein the first system is a 5G system (5GS) and the second system is an Evolved Packet System (EPS).

3. The method of claim 2, wherein the indication indicates 5GS to EPS handover.

4. The method of claim 1 wherein the step of determining whether the UE policies need to be updated at the UE further comprises re-evaluating applicable UE policies for the UE when the UE is in the second system.

5. The method of claim 1 wherein the first information is an indication indicating “5GS handover to EPC”.

6. The method of claim 1 further comprising when more than one policy association are established with the UE-PCF by more than one SM-PCF:
selecting a UE policy association that includes the indication of UE handover from the first system to the second system;
generating the UE policies; and
sending the UE policies over the selected UE policy association for delivery to the UE in the second system.

7. The method of claim 1 any of claims 1 to 6, wherein the UE policies comprise at least one of Access network discovery & selection policies (ANDSP), UE Route Selection Policies (URSP), Vehicle to anything (V2X) Policies and proximity (ProSe) Policies (ProSeP).

8. (canceled)

9. (canceled)

10. A method performed by a user equipment (UE) the method comprising:
sending a Registration Request message to a network node to register the UE in a first system; and
obtaining UE policies from the first system;
wherein the Registration Request includes information indicating to the first system a capability of the UE to support receiving updated UE policies over a second system if the UE moves from the first system to the second system, and the second system is different from the first system.

11. The method of claim 10 wherein the information is included in a UE policy container.

12. The method of claim 10 wherein the information is included as an information element of the Registration Request message.

13. The method of claim 10 wherein the first system is a 5G system and the second system is an Evolved Packet System (EPS).

14. The method of claim 10, wherein the method further comprises
moving to the second system; and
receiving the UE policies over the second system in response to the UE having indicated the UE policies can be updated over the second system.

15. The method of claim 10, wherein the UE policies comprise at least one of Access network discovery & selection policies (ANDSP), UE Route Selection Policies (URSP), Vehicle to anything (V2X) Policies and proximity (ProSe) Policies (ProSeP).

16. A user equipment (UE) comprising:
a processing circuitry; and
a memory coupled with the processing circuitry, wherein the memory includes instructions that when executed by the processing circuitry causes the UE to
send a Registration Request message to a network node to register the UE in a first system; and
obtain UE policies from the first system;
wherein the Registration Request includes information indicating to the first system a capability of the UE to support receiving updated UE policies over a second system if the UE moves from the first system to the second system and the second system is different from the first system.

17. (canceled)

18. (canceled)

19. (canceled)

20. (canceled)

21. (canceled)

22. (canceled)

23. (canceled)

24. (canceled)

25. (canceled)

26. The User Equipment (UE) of claim 16 wherein the information is included in a UE policy container.

27. The User Equipment (UE) of claim 16 wherein the information is included as an information element of the Registration Request message.

28. The User Equipment (UE) of claim 16 wherein the first system is a 5G system and the second system is an Evolved Packet System (EPS).

29. The User Equipment (UE) of claim 16, wherein the processing circuitry causes the UE to further
move to the second system; and
receive the UE policies over the second system in response to the UE having indicated the UE policies can be updated over the second system.

30. The User Equipment (UE) of claim 16, wherein the UE policies comprise at least one of Access network discovery & selection policies (ANDSP), UE Route Selection Policies (URSP), Vehicle to anything (V2X) Policies and proximity (ProSe) Policies (ProSeP).
